(19) United States
(12) Patent Application Publication
(10) Pub. No.: US 2020/0409920 A1
(43) Pub. Date: Dec. 31, 2020

(54) ENTITY-ACTION-USER GRAPH BASED INDEXING

(71) Applicant: Google LLC, Mountain View, CA (US)

(72) Inventor: Andres Paez Martinez, San Francisco, CA (US)

(21) Appl. No.: 16/453,021

(22) Filed: Jun. 26, 2019

(51) Int. Cl. G06F 16/22; G06F 16/901

(52) U.S. Cl. CPC G06F 16/2237; G06F 16/2264; G06F 16/9024

(57) ABSTRACT

Methods, systems, and apparatus, including computer programs encoded on a computer storage medium, for graph based indexing. In one aspect, a method includes obtaining a log of actions performed by users in relation to entities, storing a vector in vector space for each of the entities, for each of the actions, and for each of the users, obtaining an indication that a particular user of the users performed a particular action of the actions in relation to a particular entity of the entities, determining a resultant vector in the vector space based on a combination of the vector of the particular entity, the vector of the particular action, and the vector for the particular user, and selecting a combination of one of the vectors of the entities and one of the vectors of the actions that is closest to the resultant vector.

### FIELD

This specification relates to storing and retrieving data.

### BACKGROUND

Computing systems may handle various actions from users. For example, a computing system may first receive a request from a user to view a trailer of a movie and then receive another request from the user to view showtimes for the movie.

### SUMMARY

Computer systems may use a large amount of data to handle various actions from users. As the amount of data increases, efficient storage and retrieval of the data is becoming increasingly important. The present disclosure relates to efficient storage and retrieval of data via entity-action-user graph based indexing. A system using entity-action-user graph based indexing may represent entities, actions, and users with corresponding vectors in a vector space to provide efficient indexing. Such an indexing may allow the amount of memory needed to store the data to be reduced compared to other techniques, and the data to be more quickly stored and retrieved compared other techniques.

Particular embodiments of the subject matter described in this specification can be implemented so as to realize one or more of the following advantages. The techniques disclosed herein may allow users, actions and entities to be represented using less memory than other techniques. Each users, action and entity is represented as a respective vectors in a common vector space. The components of each vector are adjusted by a machine learning process, through which valid combinations of users, actions and entities (e.g., combinations that have been observed in log data) are generally formed into clusters in the vector space, whereas invalid combinations (e.g., combinations that have not been observed in log data) are generally not formed into clusters. Representing users, actions and entities as vectors in a vector space allows the machine learning process to be performed effectively using parallel processing techniques. The vector space can be used to predict a particular action on a particular entity that a particular user is most likely to perform next. This, in turn, can allow pre-processing and/or pre-caching of data used to perform the next action.

In general, one innovative aspect of the subject matter described in this specification can be embodied in methods that include the actions of obtaining a log of actions performed by users in relation to entities, storing, based on the log of actions, a vector in vector space for each of the entities, for each of the actions, and for each of the users, obtaining an indication that a particular user of the users performed a particular action of the actions in relation to a particular entity of the entities, determining a resultant vector in the vector space based on a combination of the vector of the particular entity, the vector of the particular action, and the vector for the particular user, selecting a combination of one of the vectors of the entities and one of the vectors of the actions that is closest to the resultant vector, and providing an indication of the entity and the action that corresponds to the combination that was selected.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In certain aspects, storing, based on the log of actions, a vector in vector space for each of the entities, for each of the actions, and for each of the users includes for each of the entities related to the actions performed by the user, storing a respective vector of n-dimensions, for each of the actions performed by the user, storing a respective vector of n-dimensions, and for each of the users that performed the actions, storing a respective vector of n-dimensions.

In some implementations, storing, based on the log of actions, a vector in vector space for each of the entities, for each of the actions, and for each of the users includes obtaining, based on the log of actions, training data that includes a plurality of positive samples and a plurality of negative samples, each positive sample representing an action performed by a user in relation to an entity as indicated by the log, each negative sample representing an action not performed by a user on an entity and determining values for the vectors to increase distances between combinations of vectors for each set of user, entity, and action in the negative samples and combinations of vectors for users, entities, and actions in the vector space compared to distances between combinations of vectors for each set of user, entity, and action in the positive samples and a combination of vectors for users, entities, and actions in the vector space.

In some aspects, obtaining a log of actions performed by users in relation to entities includes obtaining multiple entries, where each entry indicates an action of the actions that a user of the users performed in relation to an entity of the entities. In certain aspects, determining a resultant vector in the vector space based on a combination of the vector of the particular entity, the vector of the particular action, and the vector for the particular user includes for each dimension in the vector space, adding corresponding values for that dimension for the vector of the particular entity, the vector of the particular action, and the vector for the particular user. In some implementations, selecting a combination of one of the vectors of the entities and one of the vectors of the actions that is closest to the resultant vector includes determining distances from the resultant vector to combinations of the vectors of the entities and the vectors of the actions and determining that the combination of the one of the vectors of the entities and the one of the vectors of the actions has a smallest distance to the resultant vector of the distances of all the combinations of vectors and entities.

In some aspects, selecting a combination of one of the vectors of the entities and one of the vectors of the actions that is closest to the resultant vector includes determining a n-dimensional shape that corresponds to the combination of one of the vectors of the entities and one of the vectors of the actions that is closest to the resultant vector, where the vector space corresponds to multiple different n-dimensional shapes, determining the vectors of the entities that are within the n-dimensional shape, for each of the vectors of the entities that are within the n-dimensional shape, determining distances of the resultant vector to combinations of the vector of the entity and the vectors of the actions, and selecting the combination of the vector of the entity and the vector of the action that has the shortest distance from the resultant vector.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates an example system that provides graph based indexing.

FIGS. 2A & 2B are example graphs showing how graph based indexing may be used to retrieve data.

FIG. 3 is a flow diagram that illustrates an example of a process for graph based indexing.

FIG. 4 is a diagram of examples of computing devices.

Like reference numbers and designations in the various drawings indicate like elements.

### DETAILED DESCRIPTION

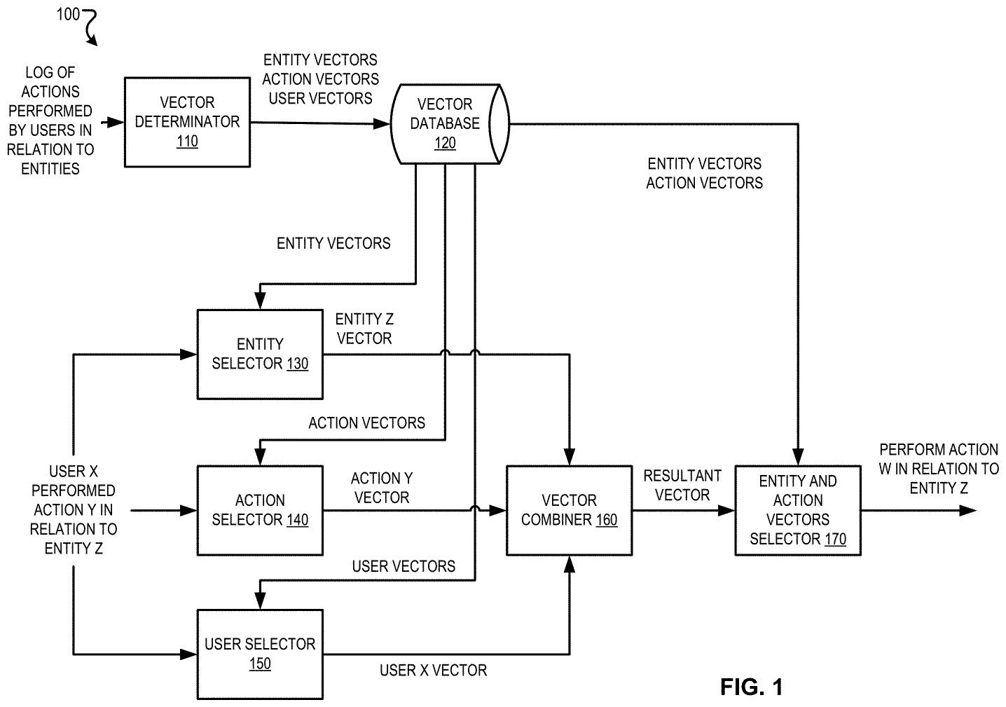

FIG. 1 is a block diagram that illustrates an example system 100 that provides a graph based indexing. Briefly, and as will be described below in more detail, the system 100 includes a vector determinator 110, a vector database 120, an entity selector 130, an action selector 140, a user selector 150, a vector combiner 160, and an entity and action vectors selector 170. The vector determinator 110, the vector database 120, the entity selector 130, the action selector 140, the user selector 150, the vector combiner 160, and the entity and action vectors selector 170 may be implemented on a single computing device or by multiple computing devices. For example, the system 100 may be implemented on a single server or across multiple servers that each implement one of the vector determinator 110, the vector database 120, the entity selector 130, the action selector 140, the user selector 150, the vector combiner 160, and the entity and action vectors selector 170.

The vector determinator 110 may obtain a log of actions performed by users in relation to entities. For example, the vector determinator 110 may obtain a log of ten billion actions performed by a billion users in relation to one hundred million entities, where the ten billion actions include twenty thousand different types of actions. The log of actions may include multiple entries, where each entry corresponds to a particular action performed by a particular user in relation to a particular entity. For example, the log of actions may include an entry that indicates that User X viewed a trailer for Movie U and a next entry that indicates that the next action that User X performed was viewing showtimes for Movie U. In this example, “view trailer” and “view showtimes” are actions, and “Movie U” is an entity. It will be appreciated that this is just one simple, easily understandable example of the types of actions and entities that may be indexed. The log may relate to any other suitable actions performed by users in relation to any suitable entity. For example, the entities may be files stored in a data storage system, and the actions may include creating, reading, executing, modifying and/or deleting such files.

The vector determinator 110 may determine vectors for each of the actions, each of the users, and each of the entities. For example, for a log of ten billion actions performed by a billion users in relation to one hundred million entities, where the ten billion actions include twenty thousand different types of actions, the vector determinator 110 may determine twenty thousand vectors for activities, one for each of the twenty thousand different types of activities, a billion vectors for users, and a hundred million vectors for entities.

The vector determinator 110 may determine the vectors to have the same number of dimensions in a same vector space of the same number of dimensions, where the values for the dimensions vary between the vectors. For example, the vector determinator 110 may determine the vectors for actions, vectors for users, and vectors for entities to each have two hundred dimensions with varying values for the dimensions.

The vector determinator 110 may determine the vectors based on a training algorithm. The training algorithm used by the vector determinator 110 may use training data that includes a plurality of positive samples and a plurality of negative samples. For example, the vector determinator 110 may obtain positive samples from the log of actions performed by users in relation to entities, and negative samples that correspond to actions that the log indicates were not performed by users in relation to entities. The training algorithm used by the vector determinator 110 may randomly initialize vectors and then given a particular user and particular entity, identify two consecutive actions, ‘p’ and ‘i’, performed by the user from the log and then identify a third action, ‘j’, that was not next performed by the user. In the algorithm, it is assumed that the probability of moving from ‘p’ to ‘i’ is given by βᵢ=d(\hat{p}+û,î) where d(x, y) is a distance function that gives the distance between x and y, and βᵢ is a bias term associated with item i. The vector determinator 110 adjusts the values of all the parameters so as to minimize the probability of j and maximize the probability of i using stochastic gradient descent.

In some implementations, the vector determinator 110 may run training in a parallel fashion where T threads can compute the changes for different vectors. At the end of computing the changes, the vector determinator 110 may merge the changes. In case of an item collision, where two or more threads try to update the same vector, the vector determinator 110 may average all changes and apply the average. In some implementations, the vector determinator 110 may attempt to reduce the magnitude of action vectors over reducing magnitudes of user vectors and entity vectors.

The vector database 120 may receive the vectors for entities (also referred to as entity vectors), the vectors for actions (also referred to as action vectors), and the vectors for users (also referred to as user vectors) determined by the vector determinator 110 and store the vectors. For example, for a log of ten billion actions performed by a billion users in relation to one hundred million entities, where the ten billion actions include twenty thousand different types of actions, the vector database 120 may store twenty thousand vectors for actions (i.e., one for each of the twenty thousand different types of actions), a billion vectors for users, and a hundred million vectors for entities.

In an example, each vector has two hundred dimensions, and the value of each dimension is stored as a four-byte floating point number. Each vector thus uses two hundred floating point numbers, or eight hundred bytes of memory. Storing all of the data in the previously-mentioned log in the vector database uses around two hundred trillion floating point numbers (i.e., two hundred times (twenty thousand plus one billion plus one hundred million)), or eight hundred Gb of storage. In contrast, if each entity and action in the previously mentioned log were to be encoded in a pairwise manner, significantly more memory (i.e., twenty thousand times one hundred million) would be needed just to represent all of possible the entity-action pairs. Thus, representing each user, entity and action as a respective vector can significantly reduce storage requirements.

The entity selector 130 may receive an indication of a particular entity in relation to which a particular action was performed by a particular user, the entity vectors from the vector database 120, and select a particular entity vector. For example, the entity selector 130 may receive an indication that User X performed Action Y in relation to Entity Z. The entity selector 130 may receive the indication, determine the entity vector that matches the entity specified by the indication, and, in response, select the entity. For example, the entity selector 130 may determine that the indication specifies Entity Z, determine that the entity vectors include a particular entity vector for Entity Z, and, in response, output the entity vector for Entity Z.

The action selector 140 may receive an indication of a particular action that was performed by a particular user in relation to a particular entity, the action vectors from the vector database 120, and select a particular action vector. For example, the action selector 140 may receive an indication that User X performed Action Y in relation to Entity Z. The action selector 140 may receive the indication, determine the action vector that matches the action specified by the indication, and, in response, select the action. For example, the action selector 140 may determine that the indication specifies Action Y, determine that the action vectors include a particular action vector for Action Y, and, in response, output the action vector for Action Y.

The user selector 150 may receive an indication of a particular user that performed a particular action in relation to a particular entity, the user vectors from the vector database 120, and select a particular user vector. For example, the user selector 150 may receive an indication that User X performed Action Y in relation to Entity Z. The user selector 150 may receive the indication, determine the user vector that matches the user specified by the indication, and, in response, select the user. For example, the user selector 150 may determine that the indication specifies User X, determine that the user vectors include a particular user vector for User X, and, in response, output the user vector for User X.

The vector combiner 160 may receive the entity vector selected by the entity selector 130, the action vector selected by the action selector 140, the user vector selected by the user selector 150, and, in response, determine a resultant vector. For example, the vector combiner 160 may receive the entity vector for Entity Z, the action vector for Action Y, the user vector for User X, and add the three vectors to obtain a resultant vector. Adding the vectors may include adding each component of each vector with the corresponding component of the other vectors.

The entity and action vectors selector 170 may obtain the resultant vector, the entity vectors, and the action vectors, select a particular combination of entity vector and action vector that is closest to the resultant vector from all the combinations of entity vectors and action vectors, and provide an indication of the particular combination. For example, the entity and action vector selector 170 may receive the resultant vector from combining the entity vector for Entity Z, the action vector for Action Y, the user vector for User X, determine that the resultant vector is closest to a combination of an action vector for Action W and an entity vector for Entity Z and, in response, output “perform Action W in relation to Entity Z.”

The entity and action vectors selector 170 may select the particular combination of entity vector and action vector using a hash-based algorithm to search the vector space. For example, locality-sensitive hashing (LSH) may be used to identify an entity vector and an action vector whose resultant vector is a neighboring vector (e.g., the nearest neighbor in the vector space) to the resultant vector generated by the vector combiner 160. As another example, a “geo-hashing” type algorithm may be used, in which the vector space is partitioned into a plurality of overlapping hypercubes, with each hypercube being identifiable by means of a hash value. The “geo-hashing” type algorithm is configured to identify any entity vectors and vectors whose resultant vectors are in the same hypercube (or an overlapping hypercube) as the resultant vector generated by the vector combiner 160. A hash-based algorithm may enable the entity and action vectors selector 170 to more quickly identify the combination that is closest to the resultant vector as distances from all combinations in the entity space may not need to be determined. Instead, the entity and action vectors selector 170 may initially determine a shape that includes the resultant vector, then identify all entity vectors within that shape, and then calculate distances from the resultant vector to combinations of the entity vectors within that shape and all the action vectors to identify the combination that is closest to the resultant vector.

In some implementations, the output of the entity and action vectors selector 170 may be used to provide recommendations to a user, perform pre-processing for an action likely to be next performed by the user, or pre-caching information for an action likely to be next performed by the user. For example, the system 100 may determine to display to the user “Click here to perform Action W in relation to Entity Z,” perform processing needed to perform Action W before a next action from the user, or cache information needed to perform Action W for Entity Z.

In some implementations, the vectors stored by the vector database 120 may be provided to other machine learning systems. The other machine learning systems get all the translation and similarity signals from the action vectors, and general user affinities from the user vectors. Serving the vectors to other systems may require a large amount of storage space to be made accessible to those systems (e.g., for five hundred twelve action vectors and two trillion entities, the order of 1024 TB of storage is needed if each vector is encoded by two hundred four-byte floating point numbers). To improve the speed of access to such a large memory space, serving logic with a dedicated cache may be used. In some implementations, the system may incorporate reinforcement learning by training on all new actions performed by users and updating the values of vectors in real time.

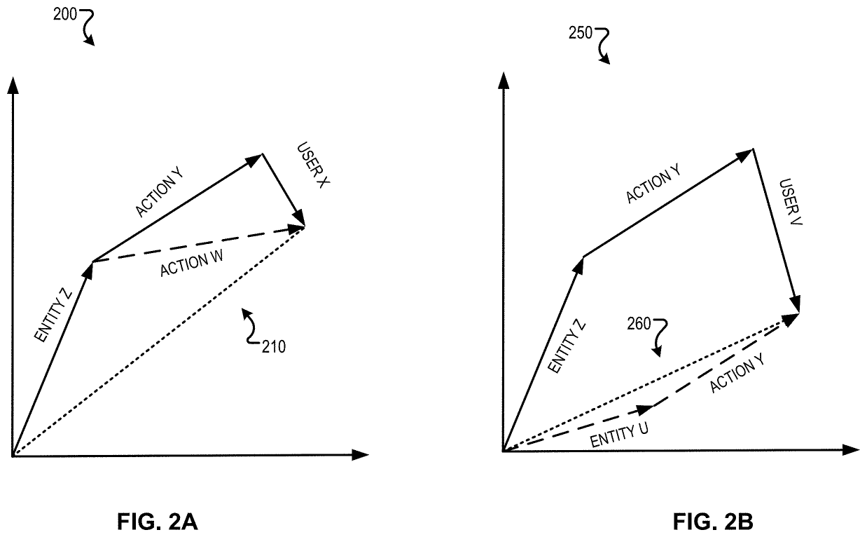

FIGS. 2A & 2B are example graphs showing how graph based indexing may be used to retrieve data. FIGS. 2A and 2B show only two dimensions for ease of explanation, but many more dimensions (e.g., two hundred dimensions) may be used in practice. FIG. 2A shows a graph 200 where after the vectors are determined, the entity vector for Entity Z, the action vector for Action Y, and the user vector for User X may be combined to arrive at a resultant vector 210. As shown in graph 200, the resultant vector 210 may point to a location in the vector space that is closest to the combination of the entity vector for Entity Z and the action vector for Action W. Accordingly, the graph 200 may indicate that the next most likely action that User X may take after performing Action Y in relation to Entity Z is performing Action W in relation to Entity Z.

FIG. 2B shows a graph 250 where after the vectors are determined, the entity vector for Entity Z, the action vector for Action Y, and the user vector for User V may be combined to arrive at a resultant vector 260. As shown in graph 250, the resultant vector 260 may point to a location in the vector space that is closest to the combination of the entity vector for Entity U and the action vector for Action Y. Accordingly, the graph 250 may indicate that the next most likely action that User V may take after performing Action Y in relation to Entity Z is performing Action W in relation to Entity Z.

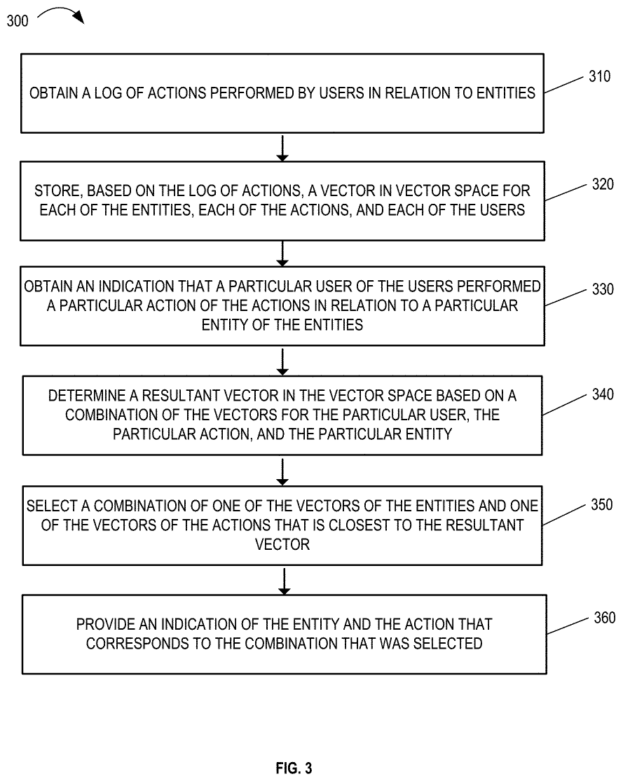

FIG. 3 is a flow diagram of a process 300 for graph based indexing. For example, the process 300 may be used by the system 100 shown in FIG. 1 or some other system.

The process 300 includes obtaining a log of actions performed by users in relation to entities (310). For example, the vector determinator 110 may obtain a log of actions performed by users in relation to entities. In some implementations, obtaining a log of actions performed by users in relation to entities includes obtaining multiple entries, where each entry indicates an action of the actions that a user of the users performed in relation to an entity of the entities. For example, the vector determinator 110 may obtain a log that includes ten billion entries, where each entry indicates a particular action performed by a particular user in relation to a particular entity.

The process 300 includes storing, based on the log of actions, a vector in vector space for each of the entities, each of the actions, and each of the users (320). For example, the vector determinator 110 may store in the vector database 120, twenty thousand action vectors, a billion user vectors, and one hundred million entity vectors.

In some implementations, storing, based on the log of actions, a vector in vector space for each of the entities, for each of the actions, and for each of the users includes for each of the entities related to the actions performed by the user, storing a respective vector of n-dimensions, for each of the actions performed by the user, storing a respective vector of n-dimensions, and for each of the users that performed the actions, storing a respective vector of n-dimensions. For example, the vector database 120 may store an array of two hundred floats for each of the user vectors, entity vectors, and action vectors, where each float represents a dimension.

In some implementations, storing, based on the log of actions, a vector in vector space for each of the entities, for each of the actions, and for each of the users includes obtaining, based on the log of actions, training data that includes a plurality of positive samples and a plurality of negative samples, each positive sample representing an action performed by a user in relation to an entity as indicated by the log, each negative sample representing an action not performed by a user on an entity and determining values for the vectors to increase distances between combinations of vectors for each set of user, entity, and action in the negative samples and combinations of vectors for users, entities, and actions in the vector space compared to distances between combinations of vectors for each set of user, entity, and action in the positive samples and a combination of vectors for users, entities, and actions in the vector space.

For example, the vector determinator 110 may generate a positive sample for each consecutive pair of actions performed by a same user as indicated by the log, and a negative sample for each action performed by a user where the negative sample indicates the action performed by the user followed by another action that was not next performed by the user as indicated by the log.

The process 300 includes obtaining an indication that a particular user of the users performed a particular action of the actions in relation to a particular entity of the entities (330). For example, the entity selector 130, action selector 140, and user selector 150 may each receive an indication that User X performed Action Y in relation to Entity Z.

The process 300 includes determining a resultant vector in the vector space based on a combination of the vectors for the particular user, the particular action, and the particular entity (340). For example, the vector combiner 160 may sum the entity vector for Entity Z, the action vector for Action Y, and the user vector for User X as the resultant vector.

In some implementations, determining a resultant vector in the vector space based on a combination of the vector of the particular entity, the vector of the particular action, and the vector for the particular user includes for each dimension in the vector space, adding corresponding values for that dimension for the vector of the particular entity, the vector of the particular action, and the vector for the particular user. For example, the vector combiner 160 may determine, for each dimension of the vectors, a value for each of the three vectors and add the values as the value for the dimension for the resultant vector.

The process 300 includes selecting a combination of one of the vectors of the entities and one of the vectors of the actions that is closest to the resultant vector (350). For example, the entity and action vectors selector 170 may select the combination of the action vector for Action W and entity vector for Entity Z as that combination may be closer than any other combination of action vector and entity vector to the resultant vector.

In some implementations, selecting a combination of one of the vectors of the entities and one of the vectors of the actions that is closest to the resultant vector includes determining distances from the resultant vector to combinations of the vectors of the entities and the vectors of the actions and determining that the combination of the one of the vectors of the entities and the one of the vectors of the actions has a smallest distance to the resultant vector of the distances of all the combinations of vectors and entities. For example, the entity and action vectors selector 170 may determine the distances from the resultant vector and each of the combinations of the entity vectors and the action vectors, rank the combinations based on distance, and then select the combination for the action vector for Action W and entity vector for Entity Z as that combination may have the shortest distance.

In some implementations, selecting a combination of one of the vectors of the entities and one of the vectors of the actions that is closest to the resultant vector includes determining a n-dimensional shape that corresponds to the combination of one of the vectors of the entities and one of the vectors of the actions that is closest to the resultant vector, where the vector space corresponds to multiple different n-dimensional shapes, determining the vectors of the entities that are within the n-dimensional shape, for each of the vectors of the entities that are within the n-dimensional shape, determining distances of the resultant vector to combinations of the vector of the entity and the vectors of the actions, and selecting the combination of the vector of the entity and the vector of the action that has the shortest distance from the resultant vector. For example, the entity and action vectors selector 170 may split the vector space up into eight shapes, determine within which shape the resultant vector points to, identify only those entity vectors that point to the shape, and then calculate distances just for combinations of the entity vectors that point to the shape and the intent vectors.

The process 300 includes providing an indication of the entity and the action that corresponds to the combination that was selected (360). For example, the entity and action vectors selector 170 may indicate that User X is next most likely to perform Action W in relation to Entity Z.

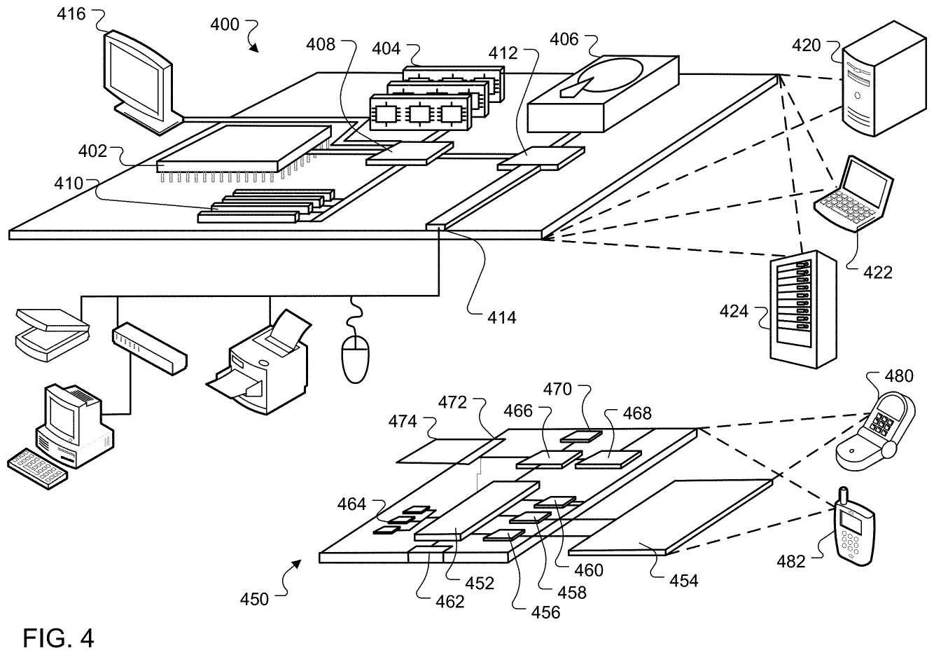

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, WiFi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used herein, the terms “machine-readable medium” “computer-readable medium” refers to any computer program product, apparatus and/or device, e.g., magnetic discs, optical disks, memory, Programmable Logic devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component such as an application server, or that includes a front end component such as a client computer having a graphical user interface or a Web browser through which a user can interact with an implementation of the systems and techniques described here, or any combination of such back end, middleware, or front end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

Various numbered embodiments of the present disclosure will now be enumerated by way of example:

Embodiment 1. A computer-implemented method comprising: obtaining a log of actions performed by users in relation to entities; storing, based on the log of actions, a vector in vector space for each of the entities, for each of the actions, and for each of the users; obtaining an indication that a particular user of the users performed a particular action of the actions in relation to a particular entity of the entities; determining a resultant vector in the vector space based on a combination of the vector of the particular entity, the vector of the particular action, and the vector for the particular user; selecting a combination of one of the vectors of the entities and one of the vectors of the actions that is closest to the resultant vector; and providing an indication of the entity and the action that corresponds to the combination that was selected.

Embodiment 2. The method of embodiment 1, wherein storing, based on the log of actions, a vector in vector space for each of the entities, for each of the actions, and for each of the users comprises: for each of the entities related to the actions performed by the user, storing a respective vector of n-dimensions; for each of the actions performed by the user, storing a respective vector of n-dimensions; and for each of the users that performed the actions, storing a respective vector of n-dimensions.

Embodiment 3. The method of embodiment 1 or embodiment 2, wherein storing, based on the log of actions, a vector in vector space for each of the entities, for each of the actions, and for each of the users comprises: obtaining, based on the log of actions, training data that includes a plurality of positive samples and a plurality of negative samples, each positive sample representing an action performed by a user in relation to an entity as indicated by the log, each negative sample representing an action not performed by a user on an entity; and determining values for the vectors to increase distances between combinations of vectors for each set of user, entity, and action in the negative samples and combinations of vectors for users, entities, and actions in the vector space compared to distances between combinations of vectors for each set of user, entity, and action in the positive samples and a combination of vectors for users, entities, and actions in the vector space.

Embodiment 4. The method of any of embodiments 1 to 3, wherein obtaining a log of actions performed by users in relation to entities comprises: obtaining multiple entries, where each entry indicates an action of the actions that a user of the users performed in relation to an entity of the entities.

Embodiment 5. The method of any of embodiments 1 to 4, wherein determining a resultant vector in the vector space based on a combination of the vector of the particular entity, the vector of the particular action, and the vector for the particular user includes for each dimension in the vector space, adding corresponding values for that dimension for the vector of the particular entity, the vector of the particular action, and the vector for the particular user.

Embodiment 6. The method of any of embodiments 1 to 5, wherein selecting a combination of one of the vectors of the entities and one of the vectors of the actions that is closest to the resultant vector comprises: determining distances from the resultant vector to combinations of the vectors of the entities and the vectors of the actions; and determining that the combination of the one of the vectors of the entities and the one of the vectors of the actions has a smallest distance to the resultant vector of the distances of all the combinations of vectors and entities.

Embodiment 7. The method of any of embodiments 1 to 6, wherein selecting a combination of one of the vectors of the entities and one of the vectors of the actions that is closest to the resultant vector comprises: determining a n-dimensional shape that corresponds to the combination of one of the vectors of the entities and one of the vectors of the actions that is closest to the resultant vector, wherein the vector space corresponds to multiple different n-dimensional shapes; determining the vectors of the entities that are within the n-dimensional shape; for each of the vectors of the entities that are within the n-dimensional shape, determining distances of the resultant vector to combinations of the vector of the entity and the vectors of the actions; and selecting the combination of the vector of the entity and the vector of the action that has the shortest distance from the resultant vector.

Embodiment 8. An apparatus configured to perform the method of any of embodiments 1 to 7.

Embodiment 9. A computer program comprising instructions that, when executed by a computer, cause the computer to perform the method of any of embodiments 1 to 7.

Embodiment 10. A computer readable medium having instructions stored thereon that, when executed by a computer, cause the computer to perform the method of any of embodiments 1 to 7.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

In some implementations, logs need not be human-accessible, so that privacy and security can be maintained, and that collection and use of the logs could be limited to only where the user has provided prior consent. Furthermore, a user may be permitted to view, delete portions of, and even the entirety of that user's logs. And similarly, a user may be permitted to exclude certain action types and/or data associated with actions, in advance, again to provide users with privacy and security controls.

What is claimed is:

1. A computer-implemented method comprising:
obtaining a log of actions performed by users in relation to entities;
storing, based on the log of actions, a vector in vector space for each of the entities, for each of the actions, and for each of the users;
obtaining an indication that a particular user of the users performed a particular action of the actions in relation to a particular entity of the entities;
determining a resultant vector in the vector space based on a combination of the vector of the particular entity, the vector of the particular action, and the vector for the particular user;
selecting a combination of one of the vectors of the entities and one of the vectors of the actions that is closest to the resultant vector; and
providing an indication of the entity and the action that corresponds to the combination that was selected.

2. The method of claim 1, wherein storing, based on the log of actions, a vector in vector space for each of the entities, for each of the actions, and for each of the users comprises:
for each of the entities related to the actions performed by the user, storing a respective vector of n-dimensions;
for each of the actions performed by the user, storing a respective vector of n-dimensions; and
for each of the users that performed the actions, storing a respective vector of n-dimensions.

3. The method of claim 1, wherein storing, based on the log of actions, a vector in vector space for each of the entities, for each of the actions, and for each of the users comprises:
obtaining, based on the log of actions, training data that includes a plurality of positive samples and a plurality of negative samples, each positive sample representing an action performed by a user in relation to an entity as indicated by the log, each negative sample representing an action not performed by a user on an entity; and
determining values for the vectors to increase distances between combinations of vectors for each set of user, entity, and action in the negative samples and combinations of vectors for users, entities, and actions in the vector space compared to distances between combinations of vectors for each set of user, entity, and action in the positive samples and a combination of vectors for users, entities, and actions in the vector space.

4. The method of claim 1, wherein obtaining a log of actions performed by users in relation to entities comprises:
obtaining multiple entries, where each entry indicates an action of the actions that a user of the users performed in relation to an entity of the entities.

5. The method of claim 1, wherein determining a resultant vector in the vector space based on a combination of the vector of the particular entity, the vector of the particular action, and the vector for the particular user comprises:
for each dimension in the vector space, adding corresponding values for that dimension for the vector of the particular entity, the vector of the particular action, and the vector for the particular user.

6. The method of claim 1, wherein selecting a combination of one of the vectors of the entities and one of the vectors of the actions that is closest to the resultant vector comprises:
determining distances from the resultant vector to combinations of the vectors of the entities and the vectors of the actions; and
determining that the combination of the one of the vectors of the entities and the one of the vectors of the actions has a smallest distance to the resultant vector of the distances of all the combinations of vectors and entities.

7. The method of claim 1, wherein selecting a combination of one of the vectors of the entities and one of the vectors of the actions that is closest to the resultant vector comprises:
determining a n-dimensional shape that corresponds to the combination of one of the vectors of the entities and one of the vectors of the actions that is closest to the resultant vector, wherein the vector space corresponds to multiple different n-dimensional shapes;
determining the vectors of the entities that are within the n-dimensional shape;
for each of the vectors of the entities that are within the n-dimensional shape, determining distances of the resultant vector to combinations of the vector of the entity and the vectors of the actions; and
selecting the combination of the vector of the entity and the vector of the action that has the shortest distance from the resultant vector.

8. A system comprising:
one or more computers and one or more storage devices storing instructions that are operable, when executed by the one or more computers, to cause the one or more computers to perform operations comprising:
obtaining a log of actions performed by users in relation to entities;
storing, based on the log of actions, a vector in vector space for each of the entities, for each of the actions, and for each of the users;
obtaining an indication that a particular user of the users performed a particular action of the actions in relation to a particular entity of the entities;
determining a resultant vector in the vector space based on a combination of the vector of the particular entity, the vector of the particular action, and the vector for the particular user;
selecting a combination of one of the vectors of the entities and one of the vectors of the actions that is closest to the resultant vector; and
providing an indication of the entity and the action that corresponds to the combination that was selected.

9. The system of claim 8, wherein storing, based on the log of actions, a vector in vector space for each of the entities, for each of the actions, and for each of the users comprises:
for each of the entities related to the actions performed by the user, storing a respective vector of n-dimensions;
for each of the actions performed by the user, storing a respective vector of n-dimensions; and
for each of the users that performed the actions, storing a respective vector of n-dimensions.

10. The system of claim 8, wherein storing, based on the log of actions, a vector in vector space for each of the entities, for each of the actions, and for each of the users comprises:
obtaining, based on the log of actions, training data that includes a plurality of positive samples and a plurality of negative samples, each positive sample representing an action performed by a user in relation to an entity as indicated by the log, each negative sample representing an action not performed by a user on an entity; and
determining values for the vectors to increase distances between combinations of vectors for each set of user, entity, and action in the negative samples and combinations of vectors for users, entities, and actions in the vector space compared to distances between combinations of vectors for each set of user, entity, and action in the positive samples and a combination of vectors for users, entities, and actions in the vector space.

11. The system of claim 8, wherein obtaining a log of actions performed by users in relation to entities comprises:
obtaining multiple entries, where each entry indicates an action of the actions that a user of the users performed in relation to an entity of the entities.

12. The system of claim 8, wherein determining a resultant vector in the vector space based on a combination of the vector of the particular entity, the vector of the particular action, and the vector for the particular user comprises:
for each dimension in the vector space, adding corresponding values for that dimension for the vector of the particular entity, the vector of the particular action, and the vector for the particular user.

13. The system of claim 8, wherein selecting a combination of one of the vectors of the entities and one of the vectors of the actions that is closest to the resultant vector comprises:
determining distances from the resultant vector to combinations of the vectors of the entities and the vectors of the actions; and
determining that the combination of the one of the vectors of the entities and the one of the vectors of the actions has a smallest distance to the resultant vector of the distances of all the combinations of vectors and entities.

14. The system of claim 8, wherein selecting a combination of one of the vectors of the entities and one of the vectors of the actions that is closest to the resultant vector comprises:
determining a n-dimensional shape that corresponds to the combination of one of the vectors of the entities and one of the vectors of the actions that is closest to the resultant vector, wherein the vector space corresponds to multiple different n-dimensional shapes;
determining the vectors of the entities that are within the n-dimensional shape;
for each of the vectors of the entities that are within the n-dimensional shape, determining distances of the resultant vector to combinations of the vector of the entity and the vectors of the actions; and
selecting the combination of the vector of the entity and the vector of the action that has the shortest distance from the resultant vector.

15. A non-transitory computer-readable medium storing software comprising instructions executable by one or more computers which, upon such execution, cause the one or more computers to perform operations comprising:
obtaining a log of actions performed by users in relation to entities;
storing, based on the log of actions, a vector in vector space for each of the entities, for each of the actions, and for each of the users;
obtaining an indication that a particular user of the users performed a particular action of the actions in relation to a particular entity of the entities;
determining a resultant vector in the vector space based on a combination of the vector of the particular entity, the vector of the particular action, and the vector for the particular user;
selecting a combination of one of the vectors of the entities and one of the vectors of the actions that is closest to the resultant vector; and
providing an indication of the entity and the action that corresponds to the combination that was selected.

16. The medium of claim 15, wherein storing, based on the log of actions, a vector in vector space for each of the entities, for each of the actions, and for each of the users comprises:
for each of the entities related to the actions performed by the user, storing a respective vector of n-dimensions;
for each of the actions performed by the user, storing a respective vector of n-dimensions; and
for each of the users that performed the actions, storing a respective vector of n-dimensions.

17. The medium of claim 15, wherein storing, based on the log of actions, a vector in vector space for each of the entities, for each of the actions, and for each of the users comprises:
obtaining, based on the log of actions, training data that includes a plurality of positive samples and a plurality of negative samples, each positive sample representing an action performed by a user in relation to an entity as indicated by the log, each negative sample representing an action not performed by a user on an entity; and
determining values for the vectors to increase distances between combinations of vectors for each set of user, entity, and action in the negative samples and combinations of vectors for users, entities, and actions in the vector space compared to distances between combinations of vectors for each set of user, entity, and action in the positive samples and a combination of vectors for users, entities, and actions in the vector space.

18. The medium of claim 15, wherein obtaining a log of actions performed by users in relation to entities comprises:
obtaining multiple entries, where each entry indicates an action of the actions that a user of the users performed in relation to an entity of the entities.

19. The medium of claim 15, wherein determining a resultant vector in the vector space based on a combination of the vector of the particular entity, the vector of the particular action, and the vector for the particular user comprises:
for each dimension in the vector space, adding corresponding values for that dimension for the vector of the particular entity, the vector of the particular action, and the vector for the particular user.

20. The medium of claim 15, wherein selecting a combination of one of the vectors of the entities and one of the vectors of the actions that is closest to the resultant vector comprises:
determining distances from the resultant vector to combinations of the vectors of the entities and the vectors of the actions; and
determining that the combination of the one of the vectors of the entities and the one of the vectors of the actions has a smallest distance to the resultant vector of the distances of all the combinations of vectors and entities.
